(19) United States
(12) Patent Application Publication
(10) Pub. No.: US 2011/0191152 A1
(43) Pub. Date: Aug. 4, 2011

(54) ASSIGNING A MOBILE-REDEEMABLE PERSONAL IDENTIFICATION NUMBER TO A CONSUMER AS A MOBILE REWARD OR FOLLOWING A PURCHASE OF A PROMOTIONAL ITEM

(75) Inventor: Gary David Schwartz, Toronto (CA)

(73) Assignee: IMPACT MOBILE INC., Toronto, ON (CA)

(21) Appl. No.: 13/055,277

(22) PCT Filed: Jul. 22, 2008
(86) PCT No.: PCT/CA2008/001334

§ 371 Date: Apr. 22, 2011

(51) Int. Cl. G06Q 30/00

(52) U.S. Cl. 705/14.1

(57) ABSTRACT

An unique personal identification number (PIN) is issued when a promotional product is purchased. The consumer receives a receipt with information on how to redeem the PIN with a mobile communication device and qualify for a reward. An MSP (mobile service provider) is able to track the consumer's redemption actions to the consumer's mobile telephone number when the consumer redeems the PIN. In another example, the consumer is able to redeem a generic coupon at a point of sale (POS), redeem a PIN by electronically scanning a mobile phone at the POS, and then use the PIN to obtain rewards. A method, system and software product for issuing and redeeming PINs are described.

### FIELD OF THE INVENTION

The present invention relates to marketing and promotional activities of branded products, including branded packaged services, in association with mobile communications devices such as mobile phones or cell phones, smartphones, wireless handheld devices, personal digital assistants (PDAs), and the like.

### BACKGROUND OF THE INVENTION

Conventional marketing and promotional programs utilize printed coupons, radio and television advertising, advertising in print and electronic media and the like. Historically, retailers and manufacturers of brand products have struggled to improve the efficacy of their traditional efforts at successfully encouraging consumers to recognize and purchase their selected brand products. Traditional advertising techniques, such as for example, printed ads and mailed coupons have demonstrated very limited success in catching the attention of prospective customers. In addition, those traditional techniques have been relatively costly, with very small response rates, thus limiting the opportunities of start up companies to promote their promising, newly developed products, and imposing significant cost burdens on long established businesses with many different brand products. In addition, printed coupons and similar forms of traditional promotions do not allow for any ongoing relationship with the consumer.

With the recent expansion of the internet, brand suppliers have attempted to promote and sell brand products through various techniques directed at the growing number of consumers who have personal computers or other access to the internet. These efforts have also had limited success even though advertising materials may be distributed at relatively low cost to millions of potential customers, provided the advertisers have access to up to date email addresses for their intended target audiences. The difficulty in obtaining reliable, up to date email addresses and other desirable information related to their target audiences has led to the practice of spamming. That approach has created negative consumer responses, the development of anti-spam software filters, legal restrictions against spamming in some jurisdictions, and other impediments to these mass marketing efforts.

Very recently, the numbers of personal mobile communications devices such as telephones, smartphones, and the like, have grown throughout the world and continue to expand at surprising rates. It has also been observed that many young adults, professionals and other individuals prefer to use mobile phones for personal and work related communications. In many instances, members of this group will not install conventional land-line based phones in their homes. Advertisers and brand suppliers have exhibited a strong desire to target these potential consumers by using conventional advertising techniques, including print media, radio, television and internet based ads, and the like, with limited success and many of the drawbacks associated with traditional promotional programs.

Such attempts have also suffered from losses associated with dishonest redemptions by consumers, retail employees and others who did not qualify for the intended incentives or rewards budgeted for those promotions.

Consequently, there is a need for a promotional and marketing program to attract a wide range of potential customers for brand products, in an effective manner. Similarly, there is a need for a method of promoting products which allows brand sources to encourage redemption of promotional incentives, identify individual target customers, track the promotional efforts and compile the results of such efforts, and track the redemption behaviors of the target audiences. There is also a need for a simplified process of redeeming promotional incentives and issuing consumer rewards associated with selected brands. There is also a particular need for such programs to be secure, with features to inhibit dishonest use and fraudulent redemptions of promotional incentives such as coupons.

Various aspects of the present invention are desirable solutions for one or more of the disadvantages associated with traditional promotional programs. The advantages and potential benefits of the present invention will become apparent to those skilled in the art, upon a review of the present specification. The following terms will be helpful in understanding the various aspects of the present invention.

A brand supplier includes a corporate entity that produces and or markets brand products.

A product is a packaged item or packaged service that is typically sold at a retail location or through other channels. An unique product may be associated with an unique product identifier, for example, an unique code.

In a typical retail sales transaction, a point of sale cashier enters information into a terminal at the point of sale concerning the items selected for purchase, including the unique codes corresponding to the items included in the transaction. The nature and type of unique codes available for use in commercial transactions is evolving. Various aspects of the present invention may be adapted for use in association with existing and evolving codes. It will be understood that certain unique codes are intended to distinguish product categories from other product categories (for example, to distinguish “peaches” from “apples”), rather than to distinguish between specific brands of products (for example, Brand X pants and Brand Y pants). In certain instances, retailers may wish to promote the sale of a general product category rather than a particular brand of product from competitive brands of similar products. Various aspects of the invention may be adapted to address these different circumstances.

### SUMMARY OF THE INVENTION

With reference to the present invention, a mobile service provider (MSP) is the application layer that typically hosts the business logic to assign, track and redeem PINs, ballots, loyalty points and coupons. Some of this business logic may be hosted remotely as an ASP (application service provider). In other instances, a POS PIN client (sometimes also called a POS middleware client) will locally host some of the mobile service provider's business logic. (The Term Pos Means a Point of Sale.)

A retail network is an aggregate or group of retailers operating within a network. When the invention is in use, a retail network may install the POS PIN client's locally hosted business logic.

PINs (Personal Identification Numbers) may be updated via batch processing between the local POS PIN client and the remote mobile service provider. As most POS applications do not allow for continuous call-outs for a PIN, batch or block processing allows a scheduled update of a quantity of PINs that are hosted locally. Batch PINs may be maintained by a centralized web service at retail which interfaces with the individual POS terminals.

An SMS gateway is placed between two SMSCs, acting as a relay between the two SMSCs. It is able to translate one SMSC (short message service center) protocol to another, and can be used by two different wireless carriers to interconnect their respective SMSCs.

A POS basket is the total sum of the products purchased (in a single sale transaction) at the retail POS.

A global PIN or super PIN may be used when multiple PINs “personal identification numbers” are issued in a single sales transaction. One global PIN may be encoded with the information necessary to identify all of the PINs associated with that transaction.

A generic coupon is the brand supplier's promotional offer that is placed in print, online or other promotions for a discount or reward at participating retail POS locations.

A mobile coupon is the information derived from a generic coupon (or other incentive) plus the added metadata necessary to make the coupon (incentive) unique and trackable to the host mobile consumer.

A mobile-redeemable incentive (for example, a mobile coupon, one or more mobile loyalty points, or a mobile sweepstake ballot) may be redeemed by directly using a mobile communication device as described further below. However, the mobile-redeemable incentive may also be redeemed in other ways, for example, by accessing a website via the internet and submitting information relating to the incentive, to facilitate an association of a mobile-redeemable PIN with the customer's mobile device.

Similarly, a mobile-redeemable PIN may be redeemed by using the customer's mobile device, or in another manner that will associate the PIN with the customer's mobile device.

The invention is associated with promotional and marketing activities associated with mobile communications devices to enable or enhance the effectiveness of promoting or marketing branded products. In one aspect, the invention is directed to tracking consumer redemptions of promotional rewards. In another aspect, the invention may provide a cost effective medium to distribute promotional rewards via electronic communications devices. The invention may also provide a secure method or system associated with marketing and promotions directed to selected customers within a larger group of people using mobile communications devices. The invention may also provide a secure way to distribute rewards at POS associated with the purchase of specific brand merchandise, and specifically by printing PINs on consumer receipts that may be redeemed by various means, including but not limited to via mobile communication devices.

The present invention may be used to promote the sale of branded products (which also include branded packaged services) through in-store acquisition of branded products or out-of store promotions designed to enhance retention of mobile rewards including one or more the following rewards: mobile sweepstake ballots (also called, mobile contest ballots), mobile loyalty points, and mobile coupons. As an example of an acquisition solution, PINs may be issued to enable consumers to receive consumer rewards following the acquisition of one or more branded products. In this acquisition example, the invention includes a method of assigning one unique personal identification number (PIN) for each promotional product sold to a consumer or one global PIN (for example, a “super” PIN) for multiple promotional products sold at the retail Point-of-Sale (POS) terminal for subsequent redemption by the consumer via their personal mobile communications device. If any promotional products are identified on the final transaction basket a PIN is dynamically printed on the transaction receipt (paper) and the PIN may be redeemed via the consumer's mobile device (phone) for a reward tracked to their phone number. The invention also includes a system for operation in accordance with this method, and a software product for programming a system for such operation in accordance with this method.

In another example of this invention, involving a retention solution, PINs may be issued as a process of rewarding consumers via mobile phones or other communications devices based on mobile sweepstake ballots, mobile loyalty points or mobile coupons. In some promotional activities, the retention program may involve immediately issuing mobile coupons to the consumer's mobile device, for example a mobile phone, to initiate the program with the consumer. In some instances, the mobile coupon may be scanned by the POS as a generic promotional code but when the mobile coupon is scanned, the scanned information will have embedded metadata to allow the mobile service provider, retailer, the brand supplier or others to track the individual consumer's redemption behavior associated with that coupon, and other historical redemption behavior, all of which information may be stored in a database, for use by the MSP, or by the retailer or brand supplier, as the case may be. In other instances, mobile coupons may be issued to the consumer's phone as the final reward when a certain number of loyalty points are collected by the consumer and are traced to the consumer's device, or a winning sweepstake ballot is drawn and awarded to the consumer's device. In this example, the invention also includes a software product and a system embodying the present method.

In another example, the invention is a method of assigning a mobile-redeemable PIN to a customer, comprising the following steps. An unique code associated with a product is examined following either the sale of the product to the customer, or following the submission by the customer of a mobile-redeemable incentive associated with the product. In the first instance within this example, the unique code (for example, a Stock-keeping unit (SKU); a Price Look-Up code (PLU); an Universal Product Code (UPC); an European Article Number (EAN); a Global Trade Item Number (GTIN); or an Australian Product Number (APN)), may be detected by scanning the product purchased at the POS and causing a unique PIN to be printed on the consumer's receipt. (The unique PIN may be brought to the attention of the customer in some other manner, other than by printing the PIN on the receipt.) In the second instance, the unique code associated with the product may be depicted on a printed coupon associated with the product which is submitted at the POS, or the unique code may be derived by scanning electronic information stored in the mobile device which is associated with an electronic coupon previously delivered to the mobile device. The incentive may be a mobile coupon, one or more mobile loyalty points, and a mobile sweepstake ballot. For example, the customer may submit the mobile redeemable incentive at a POS which participates in a promotional program. A determination is made whether the product is eligible for a consumer reward by comparing the unique code with a database comprising eligible unique codes. Preferably, each eligible unique code corresponds to a promotional product. If it is determined that the product is one of the promotional products, the mobile-redeemable PIN is issued and is available for assignment to the personal mobile communications device associated with the customer. After the PIN is issued, the customer will be notified, for example, by way of a printed receipt, that the customer is eligible for the consumer reward by redeeming the mobile-redeemable PIN. The printed receipt will encourage the customer to communicate the PIN to a designated Mobile Service Provider (MSP). Upon receipt by the MSP of an initial communication from the customer, the PIN will be associated with the customer's mobile device.

In a preferred aspect of the invention, a text message is sent by a Mobile Service Provider (MSP) to the customer's mobile device to notify the customer of his/her eligibility for a consumer reward. The customer may be encouraged to redeem the PIN by following certain prescribed rules. The text message from the MSP may also include information encouraging the customer to visit a website containing more information about the promotional or marketing program.

In some instances the PIN may be redeemed on behalf of the customer by sending a text message from the mobile device to the MSP in accordance with instructions printed on a customer receipt, following the purchase of the promotional product. In other instances, the PIN may be redeemed via the internet by sending an email, or accessing an internet website associated with the MSP, on behalf of the customer, and by entering information requested at the website to redeem the PIN assigned to the customer's mobile device.

In some aspects of the invention, batches of mobile-redeemable PINs may be assigned in batches to one or more POS locations operating within a retail network. This may be a particularly advantageous approach in POS sites which are not configured to maintain real-time communications with a remotely based system (for example, operated by a MSP and) set up to assign secure unique PINs for the promotion or marketing program. In this instance, the PINs assigned by the MSP in batches to a POS may be stored at sales terminals or other memory storage devices in network communication with the POS terminals. Each POS location may communicate with the MSP to determine the number of PINs which have been assigned to customers, and the POS location may receive additional PINs on a periodic basis to replenish the assigned PINs.

It will also be readily understood that customers may purchase in a single transaction multiple product units, including some like products and some unlike products. Several of those product units may be designated as promotional products, eligible for assignment of PINs. For convenience, it is preferable that each of the promotional product units purchased within a single transaction will be assigned a corresponding PIN and that information will be stored in a database for use by the MSP. Instead of notifying the customer that he/she has received a plurality of individual PINs, and put the customer to the task of separately submitting each PIN, the customer will be issued with a global PIN (also called a super PIN) so that the customer need only redeem one PIN to qualify for the multiple rewards associated with that multi-unit purchase.

In another embodiment, the invention is a method of assigning a mobile-redeemable PIN to a customer following the sale of a product. The method comprises the step of determining whether the product is eligible for a consumer reward by comparing an unique code assigned to the product with a database comprising eligible unique codes. Each eligible unique code corresponds to a promotional product. If the product is one of the promotional products, the mobile-redeemable PIN associated with the product sale is issued for assignment to the customer's personal mobile communications device, such that the PIN is available for use in notifying the customer that the customer is eligible for the consumer reward and that the customer may redeem the mobile-redeemable PIN by sending a text message including the PIN from the mobile device to a designated MSP associated with a designated short code.

In another embodiment, the invention is a method of assigning a mobile-redeemable PIN to a customer after the customer has submitted a valid coupon associated with a promotional product. The customer usually submits the coupon at a participating POS. The method includes the step of determining whether the coupon bears a valid unique code associated with the promotional product. If the coupon bears a valid unique code, the mobile-redeemable PIN will be associated with the customer's mobile device. The customer is notified of the PIN and that the PIN is available for redemption by sending a text message from the customer's mobile device to a designated MSP. In this instance, the text message will include the issued PIN. After the MSP receives the initial text message from the customer, including the PIN, the MSP associates the PIN with the customer's mobile device.

However, in a preferred embodiment, the customer may receive a mobile coupon via the customer's mobile communication device. The mobile coupon may have embedded metadata including information which associates a PIN with the customer's mobile device. (In some instances, the PIN may include the customer's telephone number associated with that mobile device, or another unique code which may be used to identify the customer's telephone number.) In this example, the customer's mobile device may be scanned at a POS terminal to access the embedded metadata, to verify that the mobile coupon is associated with an ongoing promotion and that the mobile coupon is eligible for redemption. In some instances, the metadata, including the mobile-redeemable PIN, might not be disclosed to the customer, even though the embedded PIN may be used to verify that the customer is eligible for a consumer reward.

In another embodiment, the invention is a system for assigning a mobile-redeemable PIN to a customer following the sale of a product. In this example, the system comprises a controller. The controller is programmed to determine whether the product is eligible for a consumer reward by comparing an unique code assigned to the product with a database comprising eligible unique codes. Each eligible unique code corresponds to a promotional product and when a promotional item with an eligible unique code is purchased, a PIN is issued, and preferably printed on the receipt. When the PIN is redeemed via the mobile device, the controller identifies the telephone number of the customer upon receipt of a submission on behalf of the customer. The controller assigns the mobile-redeemable PIN associated with the product sale to the telephone number of the customer, if the product is one of the promotional products. The system comprises a memory element for storing the mobile consumer's phone number and potentially other relevant information about the consumer that may be collected, in a database, and a communication element capable of managing ongoing communication with the mobile consumer (and others) if the consumer has opted into such ongoing communication. The communication element communicates information associated with the sale of the promotional product, comprising: the telephone number of the customer and the mobile redeemable PIN assigned to the customer. Typically, the communication element communicates certain aspects of that information between the system and the POS, and other aspects of the information between the system and the customer.

In another embodiment, the system assigns a mobile-redeemable PIN to a customer after examining an unique code associated with a product, following a submission on behalf of the customer of a mobile-redeemable incentive associated with the product. The system comprises a controller. The controller is programmed to determine whether the product is eligible for a consumer reward by comparing the unique code assigned to the product with a database comprising eligible unique codes. Each eligible unique code corresponds to a promotional product. In a preferred embodiment, the controller is configured to identify the customer's telephone number from metadata embedded in the mobile-redeemable incentive (for example, a mobile coupon) after the incentive has been scanned at the POS. In other instances, the controller may be configured to identify the telephone number of the customer upon receipt of a second submission of information on behalf of the customer comprising the PIN, and the controller will associate the mobile-redeemable PIN to the telephone number of the customer. The system also comprises a memory element for storing the database and a communication element. The communication element communicates information associated with the customer. The communicated information comprises the telephone number of the customer and the mobile-redeemable PIN assigned to the customer.

In another aspect, the invention is a software product for programming a system, for operation in accordance with one or more methods of the present invention.

The foregoing summary addresses some examples of the invention. Other variations, modifications and aspects of the invention will become apparent to those who are skilled in the relevant art upon a review of the entirety of the present specification.

Certain specific embodiments of the present invention are described with reference to the following drawings which are appended to the present specification. The drawings are briefly described below.

### DRAWINGS

Several preferred embodiments of the invention will be described in greater detail having regard to the following drawings in which,

FIG. 1 is a simplified schematic representation of a method of the present invention in which a PIN is issued in connection with a retail sale transaction involving a promotional product;

FIG. 2 is a simplified schematic representation of another method of the present invention in which a global PIN is issued in connection with a retail transaction involving more than one promotional product and a corresponding number of PINs; and

FIG. 3 is a simplified schematic representation of another aspect of the invention in which a mobile coupon is issued for redemption at a POS.

### DETAILED DESCRIPTION OF PREFERRED EMBODIMENTS OF THE INVENTION

Preferred embodiments of the invention will be described in detail having regard to the appended drawings. However, it will be understood that these examples illustrate certain embodiments of the invention and that the illustrated examples are not to be interpreted as limiting the scope of the invention. Persons skilled in the art will understand that the invention may be implemented for use in other forms, systems and methods and that many other variations, modifications and embodiments fall within the scope of the invention.

The following detailed description will illustrate a method of issuing PINs in association with an acquisition based transaction and a method of issuing PINs in association with a retention based transaction.

### Examples of Acquisition Based PINs

By way of background, a brand supplier will typically identify a product for a promotion. The Mobile Service Provider will assign a defined range of unique PINs for this promotional product by associating the range of unique PINs with the unique code (product item identifier) for this promotional product.

Having regard to the example illustrated in FIG. 1, the POS PIN client is installed on a retailer's POS software or as an external device attached to the retailer's POS terminal.

The POS PIN client processes the PINs in batches from a mobile service provider on a scheduled basis to the retail network. These PINs are issued to the product item identifier corresponding to active promotions by a brand supplier. These PINs are cached at the POS terminal. (In another example, a retail network may launch its own promotional efforts associated with one or more promotional products.)

The consumer selects product(s) at the retailer. The unique product item identifiers for all selected products are electronically scanned at the POS register/terminal. Before the final transaction is closed, the POS basket is run through the POS PIN client. If one product item identifier in the POS basket corresponds with an active promotional product campaign on the mobile service provider's associated retail network, an unique PIN is assigned to that transaction and the unique PIN is printed on the customer's receipt (paper) with a predefined product message and instructions. The message printed on the receipt may take the following form: “To enter the ProductX WIN BIG draw, text message 8XER123 to 101010 now!”

The customer has the option to follow the instructions and send an SMS text message containing his/her unique PIN to the designated short code. The PIN is routed over the SMS gateway to a mobile service provider which validates the PIN and immediately sends a mobile message (MMS or SMS with optional WAP link) containing a sweepstake ballot, loyalty point or coupon to the consumer's phone.

If multiple product item identifiers in the POS basket correspond to active promotional product campaigns on the mobile service provider's associated retail network, a global PIN (super PIN) is assigned to the multiple promotional product transaction and the unique global PIN is printed on the customer's receipt (paper) with a predefined product message and instructions. The global PIN message printed on the receipt may take the following form: “Thanks for buying ProductX, ProductY and ProductZ. Text message 1W12357U to 101010 now!”

The customer has the option to follow the instructions and send an SMS text message containing his/her unique global PIN to the designated short code. The global PIN is routed over the SMS gateway to a mobile service provider which decodes the global PIN identifying the multiple promotional products from that single retail transaction and immediately sends multiple mobile messages (MMS or SMS with optional WAP links) containing a sweepstake ballot, loyalty points or coupon(s) to the consumer's phone.

Preferably, all PIN tracking is handled remotely from the POS by a mobile service provider. Otherwise, the POS client would need to track information concerning the issuance and redemption of the PIN, including when and where PIN submitted. For example, such tracking by the POS client could be problematic if the PIN is issued at an unrelated retail operation or for reasons including the following.

Many POS systems do not provide linking information to match a negative transaction with the original transaction. Therefore on returns and post voids, the POS may not be able to invalidate the original PINs issued for these negative transactions and, as an undesirable consequence, the PINs would remain valid and acceptable for redemption.

For a reprint of a receipt, the POS would need to reprint the PIN again on the duplicate receipt. However, the mobile service provider will only accept a valid PIN once and thereby avoid multiple redemptions of the PIN corresponding to the original transaction.

If PINs remain unissued at the end of a given promotion, the PINs are cancelled by the remote mobile service provider and are never redeemed. A duplicate PIN will not be accepted by the mobile service provider.

In a preferred embodiment, each PIN is encoded using upper case characters and digits. This gives 36 different possible characters per space. From this character set the following characters are preferably removed to avoid the possibility that they would be mistaken by the consumer for another digit or character:

### O0 1I G6 8B

This adaptation yields a usable character set of 28 characters per space. If the unique portion of the PIN contained 8 characters this example would have an available number of 28⁸ PINs (more than 377 billion different PINs).

In a preferred example, another character would be added to act as a check digit to prevent someone from guessing and attempting to improperly use a valid PIN.

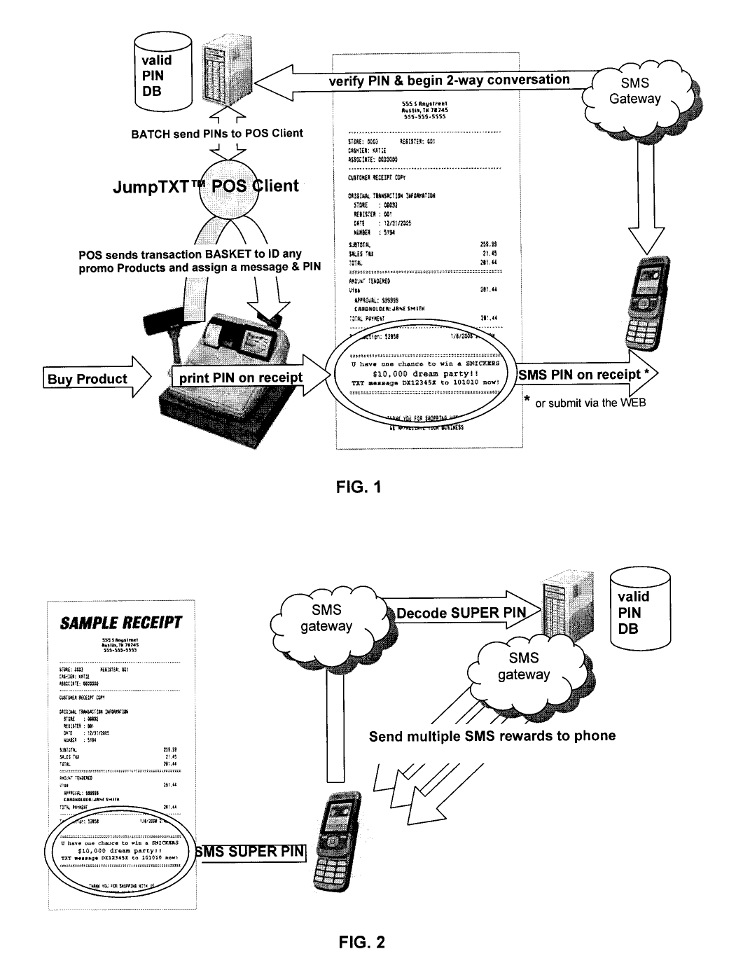

In a preferred embodiment, where global PINs are assigned, and with reference to FIG. 2, each global PIN starts with a unique prefix for the customer. After the prefix, a variable number of characters are appended representing the products that were purchased.

An example of a transaction corresponding to the issuance of a global PIN, is as follows:

Consider that the transaction involves three promotional products:
ProductX=1
ProductY=2
ProductZ=4

If all values are assigned as follows: A=0, B=1, C=2, D=3, E=4, F=5, G=6, H=7, all possible combinations of product purchases may be encoded.

Consider the following examples:
1. Customer X buys a ProductZ (which is given a value of 4 above). E=4 so append E to the unique prefix.
2. Customer Y buys a ProductX(1) and a ProductY(2). Add 1+2=3=>‘D’. Append D to the unique prefix.
3. Customer Z buys a ProductY(2) and a ProductZ(4). Add 2+4=6=>‘G’. Append G to the unique prefix.

In example “3.” above, if the unique prefix for the customer was ‘7HYUGH’, the global PIN (super PIN) printed on the receipt would be ‘7HYUGHG’

Expanding this example to the number of valid characters we could embed in the PIN (A-Z, 0-9) we will be able to encode up to 5 different products in each character after the unique prefix. For example, to encode 15 different products we would use 3 characters.

Preferably, the global PIN would also have a check digit (as a security measure) to ensure that dishonest persons could not subtly alter their global PIN codes to receive offers or rewards for products that they did not purchase.

### Example of a Retention Based Promotion

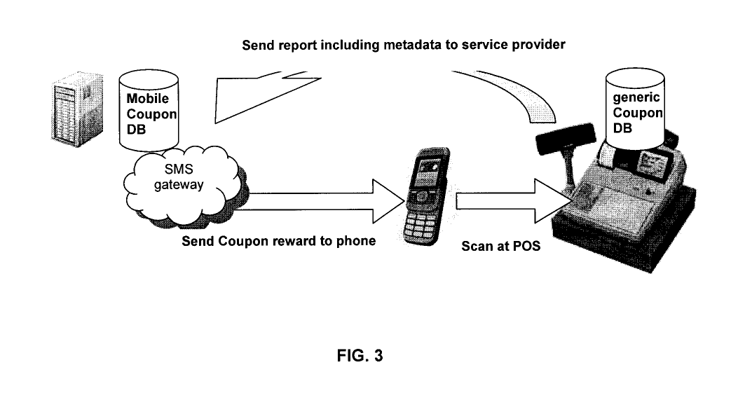

With reference to FIG. 3, a preferred embodiment of a retention based promotion is illustrated. When PINs are redeemed via the consumer's mobile device, rewards are provisioned and tracked to the customer's mobile phone. Mobile coupons may be sent to the phone immediately or the mobile coupons may be used as the final reward when a certain number of loyalty points are collected, or a winning ballot is drawn in a promotional contest. In this example, generic coupons and mobile-redeemable coupons (like PINs) are redeemed at the retail POS.

In this example, a brand supplier identifies a coupon offer for a promotional product. This offer corresponds to a generic number that can be used in print media, online media and, in the below case, on mobile media. Upon visiting the POS, this generic coupon number is appended by metadata, by the mobile service provider, to track the individual consumer's redemption behaviour.

For example, coupon number A12345 is sent to the following three consumers:
Consumer A with phone # 310 406 1190 is sent A12345X12
Consumer B with phone # 212 456 1256 is sent A12345Y18
Consumer C with phone # 647 299 1234 is sent A123451WE

In each case the mobile service provider will track the coupon to the corresponding consumer's phone number.
Consumer C's phone number=647 299 1234
Promo offer=A12345
Metadata tied back to the phone number=1WE

Each consumer may redeem his/her mobile coupon in the retail network. The coupons are sent to the corresponding consumer's phone as a SMS WAP push message. In this example, consumer C receives a message with A123451 WE embedded as a scannable code. (The embedded unique code may not be accessible or readable by the customer. However, the unique code may be used to confirm that the mobile coupon may be redeemed by the customer.)

In the preferred example, the phones are electronically scanned by an optical scanner at the POS register/terminal. The POS reads the generic coupon offer (A12345) and the POS stores the metadata (1WE).

When the POS batch reports all codes scanned within the reporting period, along with the associated metadata, the mobile service provider may track which phone number(s) redeemed the promotional offer.

This information is tracked to the specific mobile phone number and may be used to run affinity/loyalty programs for the brand supplier. This coupon redemption information coupled with the PIN redemption information allows the brand supplier to run a Customer Relationship Management (CRM) program targeted to the consumer's handset.

It will be appreciated by those skilled in the art that many other types and designs of systems, programs and methods may be used.

The embodiments described in this application are merely illustrative and are not intended to be limited to the specific features or elements as described herein. Further and other modifications and variations will be apparent to those skilled in the art, thus making it possible to practice other embodiments, all of which are within the scope and spirit of the present invention as set out in the appended claims.

1. A method of associating a unique mobile-redeemable PIN with a customer, in which the PIN has not been published on a product or product packaging, comprising:
examining a unique code associated with the product, following a transaction within the group of transactions defined by: (i) a sale of the product to the customer, and (ii) a submission by the customer of a mobile-redeemable incentive associated with the product;
determining whether the product is eligible for a consumer reward by comparing the unique code with a database comprising eligible unique codes, wherein each eligible unique code corresponds to a promotional product; and
if the product is one of the promotional products, verifying that the product is eligible for the consumer reward, associating the PIN with information associated with the transaction, and associating the PIN with a mobile communication device associated with the customer.

2. The method of claim 1, wherein the consumer reward is one or more of the group of rewards consisting of: a coupon redeemable in association with a future consumer purchase; one or more points in a loyalty reward program; and a ballot eligible for selection in a promotional contest.

3. The method of claim 1, wherein the mobile-redeemable PIN is redeemable by sending a text message, including the mobile-redeemable PIN, to a predetermined mobile service provider.

4. The method of claim 1, further comprising:
assigning one or more batches of unique mobile-redeemable PINs to one or more point of sale locations in a retail network.

5. The method of claim 4, further comprising:
determining which of the mobile-redeemable PINs assigned to the one or more point of sale locations in the retail network have been assigned from the one or more batches of mobile-redeemable PINs to a group of reward-eligible customers comprising the customer.

6. The method of claim 5, further comprising:
replenishing the mobile-redeemable PINs assigned from the one or more batches of mobile-redeemable PINs to the group of reward-eligible customers with supplemental mobile-redeemable PINs.

7. The method of claim 1, wherein the customer is notified by a text message sent to the mobile communication device of the customer's eligibility for the consumer reward.

8. The method of claim 7, wherein the text message comprises an information statement selected from the group consisting of: information about a promotional contest, information about a consumer loyalty program, and information about a promotional coupon.

9. The method of claim 1, wherein the unique code is examined after the sale of the product to the customer, the method further comprising:
determining whether the customer has been assigned more than one mobile-redeemable PIN in a single sale transaction, each PIN being associated with a promotional product;
if the customer has been assigned more than one mobile-redeemable PIN in the single sale transaction, assigning a global PIN associated with the more than one mobile-redeemable PIN, the global PIN being for use in notifying the customer that the Customer is eligible for more than one consumer rewards by redeeming the global PIN via a mobile communication device.

10. The method of claim 1, further comprising:
determining the customer's telephone number associated with the mobile communication device used to redeem the mobile-redeemable PIN, and storing the customer's telephone number and the corresponding assigned mobile-redeemable PIN in the database comprising the eligible unique codes.

11. The method of claim 1, wherein the unique code is examined after the sale of the product to the customer, the method further comprising: electronically scanning the product at a point of sale to identify the unique code assigned to the product, wherein the unique code is selected from the group consisting of:
a Stock-keeping unit (SKU); a Price Look-Up code (PLU); a Universal Product Code (UPC); a European Article Number (EAN);
a Global Trade Item Number (GTIN); and
an Australian Product Number (APN).

12. The method of claim 1, wherein the unique code is derived by examining the mobile-redeemable incentive; and the mobile-redeemable incentive is selected from the group consisting of:
a mobile sweepstake ballot; one or more mobile loyalty points; and
a mobile coupon.

13. The method of claim 1, wherein the unique code is derived by examining the mobile communication device associated with the customer.

14. The method of claim 1, wherein the mobile-redeemable PIN comprises a security code element to inhibit unauthorized redemption of the mobile-redeemable PIN.

15. The method of claim 1, wherein the mobile-redeemable PIN is redeemable online via a computer-based electronic communication initiated on behalf of the customer.

16. A system for assigning a unique mobile-redeemable PIN to a customer following the sale of a product, in which the PIN has not been published on the product or product packaging, comprising:
a controller programmed to determine whether the product is eligible for a consumer reward by comparing a unique code assigned to the product with a database comprising eligible unique codes, each eligible unique code corresponding to a promotional product;
the controller identifies the customer's telephone number associated with a mobile communication device upon receipt of a submission on behalf of the customer, and the controller assigns the mobile-redeemable PIN associated with the product sale to the telephone number of the customer, if the product is one of the promotional products;
a memory element for storing the database; and
a communication element, for communicating information associated with the sale of the promotional product, comprising: the telephone number of the customer and the mobile redeemable PIN assigned to the customer.

17. A system for associating a unique mobile-redeemable PIN with a customer after examining a unique code associated with a product, following a submission on behalf of the customer of a mobile-redeemable incentive associated with the product, and the PIN not having been published on the product or product packaging, the system comprising:
a controller, wherein the controller is programmed to determine whether the product is eligible for a consumer reward by comparing the unique code assigned to the product with a database comprising eligible unique codes, wherein each eligible unique code corresponds to a promotional product; if the product is one of the promotional products, the controller associates the mobile-redeemable PIN with information associated with the submission of the incentive;
a memory element for storing the database; and
a communication element, for communicating information associated with: the mobile-redeemable PIN, the submission of the incentive, and a mobile communication device associated with the customer.

18. In the system claimed in claim 16, the controller is configured to designate one or more batches of unique mobile-redeemable PINs to one or more point of sale locations in a retail network.

19. In the system claimed in claim 18, the controller is further configured to determine which of the mobile-redeemable PINs designated to the one or more point of sale locations in the retail network have been issued from the one or more batches of mobile-redeemable PINs to a group of reward-eligible customers comprising the customer.

20. In the system claimed in claim 19, the controller is further configured to provide supplemental unique mobile-redeemable PINs to replenish the mobile-redeemable PINs issued from the one or more batches of mobile-redeemable PINs to the group of reward-eligible customers.

21. In the system claimed in claim 16, the controller is further configured to assign a consumer reward to a personal mobile communication device associated with the customer upon receipt of the mobile-redeemable PIN assigned to the customer via a text message originating from the personal mobile communication device.

22. In the system claimed in claim 16, the controller is further configured to assign a consumer reward to a personal mobile communication device associated with the customer upon receipt of an online computer-based electronic communication initiated on behalf of the customer.

23. In the system claimed in claim 17, wherein the mobile-redeemable incentive is a mobile coupon, and the controller is programmed to receive metadata associated with the mobile coupon for storage in the memory device, for tracking a future redemption of the mobile-redeemable PIN, and for associating the future redemption with the customer.

24. In the system claimed in claim 23, the controller is further programmed to forward the metadata to a mobile service provider, via the communication element, to enable the mobile service provider to track the future redemption of the mobile-redeemable PIN and associate the future redemption with the customer.

25. A software product for operating the system as claimed in claim 16 according to a method of associating a unique mobile-redeemable PIN with a customer, in which the PIN has not been published on a product or product packaging, comprising:
examining a unique code associated with the product, following a transaction within the group of transactions defined by: (i) a sale of the product to the customer, and (ii) a submission by the customer of a mobile-redeemable incentive associated with the product;
determining whether the product is eligible for a consumer reward by comparing the unique code with a database comprising eligible unique codes, wherein each eligible unique code corresponds to a promotional product; and
if the product is one of the promotional products, verifying that the product is eligible for the consumer reward, associating the PIN with information associated with the transaction, and associating the PIN with a mobile communication device associated with the customer.

26. The method of claim 1 comprising:
storing data comprising the information associated with the transaction, the PIN, and information identifying the mobile communication device, for tracking redemptions of mobile-redeemable PINs and for associating a redemption behavior with the customer.

27. The method of claim 1 comprising:
compiling information for tracking redemption data comprising:
information associated with the transaction, the PIN, information identifying the mobile communication device and a redemption behavior associated with the customer; and
like information associated with other PIN redemption transactions initiated by other customers, and redemption behaviors associated with the other customers.

28. The method of claim 1 comprising:
storing information about the customer comprising: the PIN, information identifying the mobile communication device, and a redemption behavior associated with the customer; and
managing ongoing communications with the customer in association with a customer relationship management program.

29. The method of claim 26 comprising:
compiling information for tracking redemption data comprising:
information associated with the transaction, the PIN, information identifying the mobile communication device and a redemption behavior associated with the customer; and
like information associated with other PIN redemption transactions initiated by other customers, and redemption behaviors associated with the other customers.

30. The method of claim 26 comprising:
compiling information for tracking redemption data comprising:
storing information about the customer comprising: the PIN, information identifying the mobile communication device, and a redemption behavior associated with the customer; and
managing ongoing communications with the customer in association with a customer relationship management program.

31. The method of claim 27 comprising:
storing information about the customer comprising: the PIN, information identifying the mobile communication device, and a redemption behavior associated with the customer; and
managing ongoing communications with the customer in association with a customer relationship management program.
